(19) United States
(12) Patent Application Publication
(10) Pub. No.: US 2013/0108881 A1
(43) Pub. Date: May 2, 2013

(54) Hermetically Sealable And High Oxygen Barrier Oriented Packaging Films

(71) Applicants: Terry Ann Clark, Evanston, IL (US); Megan N. Goodrich, Evanston, IL (US)

(72) Inventors: Terry Ann Clark, Evanston, IL (US); Megan N. Goodrich, Evanston, IL (US)

(21) Appl. No.: 13/664,935

(22) Filed: Oct. 31, 2012

Related U.S. Application Data
(60) Provisional application No. 61/553,859, filed on Oct. 31, 2011.

(51) Int. Cl. B65D 81/24; B32B 37/00; B32B 27/08

(52) U.S. Cl. CPC B65D 81/24; B32B 27/08; B32B 37/00
USPC 428/483; 428/518; 493/379

(57) ABSTRACT

Hermetically sealed packages and hermetic seals based on oriented polymer films, such as oriented polyolefin polymers like biaxially oriented polypropylene (BOPP) and biaxially-oriented polyethylene terephthalatete (boPET). The films and seals are capable of providing high oxygen barrier properties effective for modified oxygen packaging.

### CROSS-REFERENCE To RELATED APPLICATION

This application claims benefit of U.S. Provisional Application No. 61/553,859, filed Oct. 31, 2011, which is hereby incorporated herein by reference in its entirety.

### FIELD

The field relates to hermetically sealable packaging films and, in particular, hermetically sealable oriented packaging films having an oxygen barrier as well as methods of forming packages thereof.

### BACKGROUND

Many perishable foods, such as cheese, coffee, meat, and snacks for a few common examples, may be packaged in a modified atmosphere environment and in manner to prevent or minimize exposure to oxygen in order to prolong their shelf life. The products may be sold in flexible packaging or pouches having high oxygen barrier properties that are also gas-flushed and hermetically sealed in order to provide good product quality throughout the shelf-life. Such package construction minimizes the presence of oxygen in the package.

Commonly, the hermetic seams in such packages are created by heat sealing facing, inside surfaces of two opposing layers or panels of the packaging film. In order to form a hermetic seal, prior films used for such packages commonly relied on a laminated or extrusion coated film construction that utilized a relatively thick inner layer of a polyolefin or ionomer-type sealant that was configured to melt at a lower temperature than other components of the film construction. During the heat sealing process, metal sealing jaws are heated, clamped closed over two abutting layers of the packaging film, held for a certain period of time, and then the bars are retracted or the film may be indexed through the sealing bars to form the seal. The heat from the metal is driven from the outside surface of the packaging film, through the body of the film, and to the interface of the two facing film layers to be sealed. The heat melts the abutting thicker inner layers of polyolefin or ionomer-type sealant of the two facing film layers together in order to form the hermetic seal.

Oxygen barrier properties are generally achieved through use of oxygen barrier layers or materials added to the film. Common oxygen barrier packages, which at the same time have a construction suitable to achieve a hermetic seal, typically are a laminate structure with oxygen barrier layers, such as PVC, SiOx-coated metalized foil, or ethylene vinyl alcohol (EVOH). Extrusion lamination is common, where polyethylene is used to bond two or more films together, but also provide a cushion and bulk to the film that enable the heated bar to properly close with sufficient and evenly distributed clamping forces throughout the width of the package to form the hermetic seal as described above. As the polyethylene layers are softer and more flexible, the prior film constructions can also include additional outer layers to provide stiffness. These stiffer outer layers often included PET. One example of a common heat sealable oxygen barrier film suitable for forming hermetic seals included, from top to bottom, an outer PET layer, an optional ink layer, an extruded polyethylene layer as an adhesive and cushion layer, and a coextruded blown film with a low density polyethylene layer as a moisture barrier and cushion layer, an adhesive or tie layer, an oxygen barrier layer, another adhesive or tie layer, and a thick sealant layer used to form the hermetic seal, which is commonly formed from low density polyethylene, ethylene vinyl acetate, metallocene-catalyzed polyethylene or ionomer.

Co-extruded biaxially oriented polypropylene (OPP) is a desired film for flexible packages. It provides stiffness, clarity, and moisture barrier properties in a single high yield film. However, it needs another material to provide oxygen barrier properties, and it has an unacceptable operating window for providing gas-hermetic heated seals.

Moreover, oriented films are generally devoid of the softer, cushion-providing layers found in the previously described laminations, and thus, have difficulty forming a consistent hermetic seal on common heated bar equipment. With the oriented films, the typical rigid sealing bars have difficulty providing uniform pressure across the surface of the seal, which was commonly absorbed in the prior films due to the softer and cushion providing polyethylene layers. Also, particularly in the case of oriented polypropylene, the maximum heated bar sealing temperature is limited to about 300° F. or lease the film with shrink and distort.

### BRIEF DESCRIPTION OF THE DRAWINGS

FIGS. 1-4 are cross-sectional views of exemplary hermetic seal structures; and

FIG. 5 is a flowchart of an exemplary method.

### DETAILED DESCRIPTION

Hermetically sealed flexible packages and hermetic seals of flexible oriented films are provided herein. In general, the hermetically sealed packages and hermetic seals are based on oriented polymer films, such as oriented polyolefin polymers like biaxially oriented polypropylene (BOPP) and biaxially-oriented polyethylene terephthalatete (boPET), capable of providing high oxygen barrier properties and hermetic seals effective for modified oxygen packaging at the same time. Such packaging is suitable for meats, cheeses, snacks, and other perishable items that are sensitive to oxygen or that deteriorate in the presence of oxygen. Not only do the films described herein provide high levels of oxygen barrier properties, but hermetic seals formed using the films herein limit ingress of oxygen and even smaller molecules through the seal.

In one aspect, the hermetically sealed flexible packages and the hermetic seals include one or more oriented polymer monoweb film layers including an oxygen barrier layer therein. The oriented polymer film is effective to provide films and hermetic seals having a high degree of thermal and dimensional stability. The films also demonstrate high oxygen barrier properties and the hermetic seals limit ingress of oxygen and smaller molecules. Such oriented films have a high degree of thermal and dimensional stability because the film is not substantially distorted and does not demonstrate substantial shrinkage upon being heat sealed even when formed from oriented polyolefin films. In one approach, the hermetic seal having a high degree of thermal and dimensional stability is even achieved in a film structure free of and/or not including any of the softer polyethylene layers that were commonly thought necessary to achieve functional hermetic seals in prior films and packaging.

In another aspect, the hermetically sealed flexible packages are achieved with an oriented polyolefin or PET film construction with an effective amount of an oxygen barrier that achieves high oxygen barrier properties even when the film is oriented by being stretched over 40 times or about 5 to 7 times elongation in a lengthwise direction and about 7 to 8 times elongation in a crosswise direction. By one approach, the films may be coextruded and biaxially oriented or stretched as a composite or monoweb film (that is, both the polymer and oxygen barrier are stretched the same time) in both a lengthwise and crosswise direction where the film may have an effective ratio of the oxygen barrier to the polymer effective to achieve the desired oxygen barrier properties and hermetic seal characteristics.

In yet another aspect, the films and packages herein may be substantially thinner than prior oxygen barrier films capable of forming hermetic seals. By one approach, the films described herein may be about 1 to about 2.5 mils thick, which are generally about 15 to about 65 percent thinner than traditional high oxygen barrier films capable of forming hermetic seals. At the same time, the hermetic seal formed with such films may be thinner than previously thought possible to achieve a hermetic seal. In some approaches, the hermetic seals may be only about 1 mm to about 3 mm thick.

In yet another aspect, the packages and hermetic seals formed from high oxygen barrier oriented polymer films may, in one approach, be constructed using an impulse-type heat sealing method or an ultrasonic-type heat sealing method rather than using a traditional heated bar heat sealing equipment. These sealing methods provide a controlled heat application that minimizes residual heat in the seal portion of the structure, which tends to shrink or deform the oriented films. In one approach, the hermetic seal may be formed using an impulse-type heat sealer configured to rapidly provide a high level of heating and then subsequently rapidly cool the heating apparatus and film so that residual heat in the film is quickly dissipated. At the same time as the heating and cooling, the impulse-type sealing also maintains continuous pressure applied to the seal. The pressure is maintained even through the cooling cycle of the equipment. A suitable impulse-type sealing equipment may be provided by, for example, Ropak Manufacturing (Alabama), Ceetak Ltd (United Kingdom); however, other suitable sealing equipment may also be used so long as the thermal and dimensional stability of the seal is maintained before, during, and after the sealing.

Turning to more of the details, a suitable structure for the hermetic seals and for the high oxygen barrier, hermetically sealed films include a biaxially oriented polyolefin, such as a biaxially oriented polypropylene (BOPP), hermetically sealed to another biaxially oriented polyolefin, such as a polypropylene (BOPP), using a sealing method effective to provide hermetic seals without heat distortion. The hermetic seal and film may also include a biaxially-oriented polyethylene terephthalatete (boPET) hermetically sealed to another biaxially-oriented polyethylene terephthalatete (boPET) in a structure with the stability described herein. Each of these oriented polymer layers may include, for example, an optional outer protective varnish, an ink layer, a polypropylene layer, an oxygen barrier layer (such as EVOH), and a thin inner polyolefin homopolymer or copolymer layer, which may be in an amount effective to form the thermal and dimensionally stable heat seal in combination with the methods described herein. While not wishing to be limited by theory, it is believed that the hermetic seals are formed by speed of the heating and welding together the facing, thin inner polyolefin or PET homopolymer or copolymer layers together with a constrained cooling.

By one approach, the packaging films provide a high level of oxygen barrier properties because they transmit less (i.e. OTR) than about 1 cc per 100 in² per 24 hours of oxygen (23° C./0% RH) through the film itself and, in some approaches, through the hermetic seal. In other approaches, the film and seals provides an OTR of about 0.8 cc per 100 in² per 24 hours of oxygen (23° C./0% RH). As mentioned above, such levels of oxygen barrier properties are even achieved in combination with oriented polymer films capable of forming the undistorted hermetic seals. This is achieved through a film construction that includes, after being oriented, an effective amount of the oxygen barrier layer, such as ethylene vinyl alcohol (EVOH) and the like, incorporated into the oriented polymer films in effective amounts relative to the polymer layers to achieve the desired oxygen barrier.

By another approach, it is believed that the oriented polymer films herein are effective to form a substantially undistorted hermetic seal having thermal and dimensional stability due to the selected film constructions in combination, in some approaches, with select methods of forming the heat seal. In some instances, the heat seals formed by the oriented polymer films herein exhibit thermal and dimensional stability because the seal itself remains undistorted upon being heat sealed and the film and heat seal portion thereof exhibits about 5 percent or less shrinkage, in other cases, less than about 3 percent shrinkage, and in yet other cases, about 1 percent or less shrinkage at the heat seal portion. In yet other approaches, the hermetic seal exhibits about 1 to about 5 percent shrinkage as compared to the unsealed film. The hermetic seals also provide a sufficient seal integrity such that the package forms no bubbles in underwater vacuum testing at about 15 inches to about 25 inches of mercury. This level of thermal and dimensional stability is even achieved without softer layers such as polyethylene and the like in the film structure. To this end, it is believed these hermetic seals, even when constructed from oriented polymers, oriented polyolefin, and oriented PET films may be capable of being formed in a commercial bagging operation, such as but not limited to, a high-speed vertical or horizontal form fill and seal bagging operations.

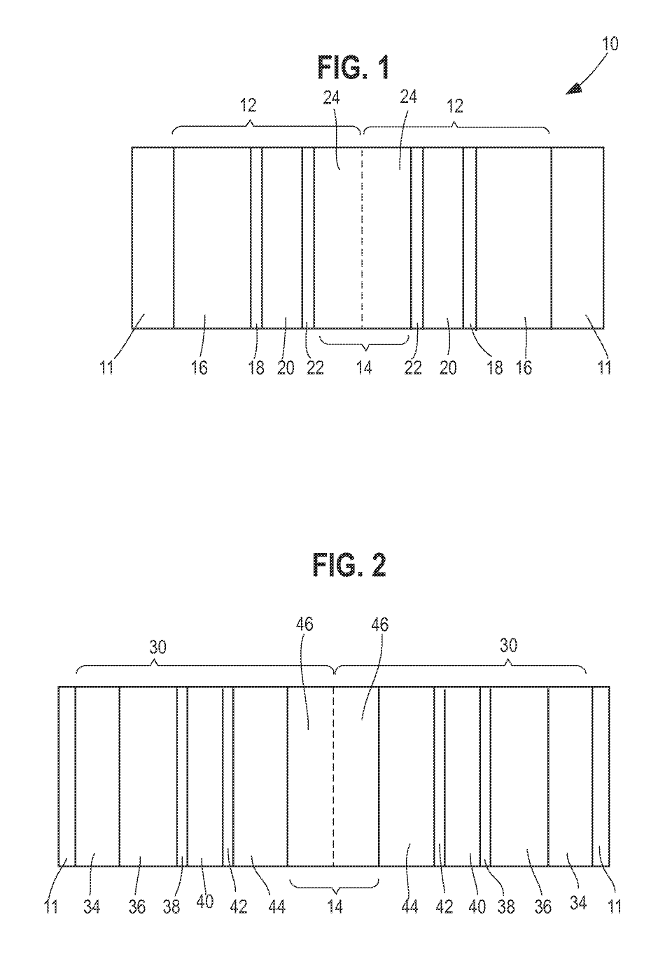

Turning to more of the specifics and to FIGS. 1 through 4, exemplary hermetically sealed flexible packages are shown that provide high levels of oxygen barrier properties combined with a hermetic seal demonstrating high levels of thermal and dimensional stability at the same time. These hermetic seals are formed with oriented films, such as biaxial oriented films in the absence of soft polyethylene layers.

In FIG. 1, one example of a hermetically sealed, high oxygen barrier film is illustrated that is based on an oriented polymer film that is also capable of forming hermetic seals demonstrating a high degree of thermal and dimensional stability at the seal interface. In this example, the seal structure includes an outer protective layer 11 and facing layers of an oriented polyolefin film 12 that forms a hermetic seal 14 having the thermal and dimensional stability at the hermetic seal interface. Each oriented polyolefin film structure 12 includes a 5-layer film monoweb construction that may include an outer polyolefin layer 16, an adhesive or tie layer 18, an oxygen barrier layer 20, another adhesive or tie layer 22, and an inner polyolefin homopolymer or copolymer layer 24 suitable for forming the hermetic seal. The films 12 are oriented in both a lengthwise and crosswise direction where both the polyolefin layer 16 and oxygen barrier layer 20 are oriented at the same time and in the same manner. The film is free of soft polyethylene layers.

By one approach, the outer protective layer 11 may include ink that is surface printed over the oriented film structure 12 with an overlacquer or clear polymer coating to protect and seal the ink and film surface. The polymer layer 16 may include polypropylene or PET, and the oxygen barrier layer 20 may include EVOH. The inner polymer layer 24 may be a propylene or ethylene homopolymer or a copolymer thereof in a thin layer effective to the form the hermetic heat seals described herein. The film structures 12 are each oriented in both a lengthwise and crosswise direction. In some cases, orientation may be at least about 40× stretching where both the polyolefin layers 16 and oxygen barrier layer 20 are oriented at the same time and in the same degree with about 5 to about 7 times stretching in a lengthwise or machine direction and about 7 to about 8 times stretching in a crosswise or transverse direction.

FIG. 2 shows another example of a possible hermetically sealed, high oxygen barrier film using oriented polymers that is capable of providing a hermetic seal with the high levels of dimensional and thermal stability. In this example, the seal structure includes the outer layer 11 and facing layers of a co-extruded oriented film 30 forming a hermetic seal 14 having a high degree of thermal and dimensional stability. More specifically, each oriented film layer 30 includes an outer polyolefin homopolymer or copolymer layer 34, a polyolefin layer 36, an adhesive or tie layer 38, an oxygen barrier layer 40, another adhesive or tie layer 42, another polyolefin layer 44, and an inner polyolefin homopolymer or copolymer layer 46 suitable for forming the hermetic seal.

By one approach, the films 30 are each oriented in both a lengthwise and crosswise direction, such as at least about 40× stretching where both the polyolefin layers 16 and oxygen barrier layer 20 are oriented at the same time as described with the films 12. As with the film structure above, the polymer layer 36 and 44 may include polypropylene, and the oxygen barrier layer 40 may include EVOH. The inner polymer layer 46 may also be propylene or ethylene homopolymer or a copolymer thereof.

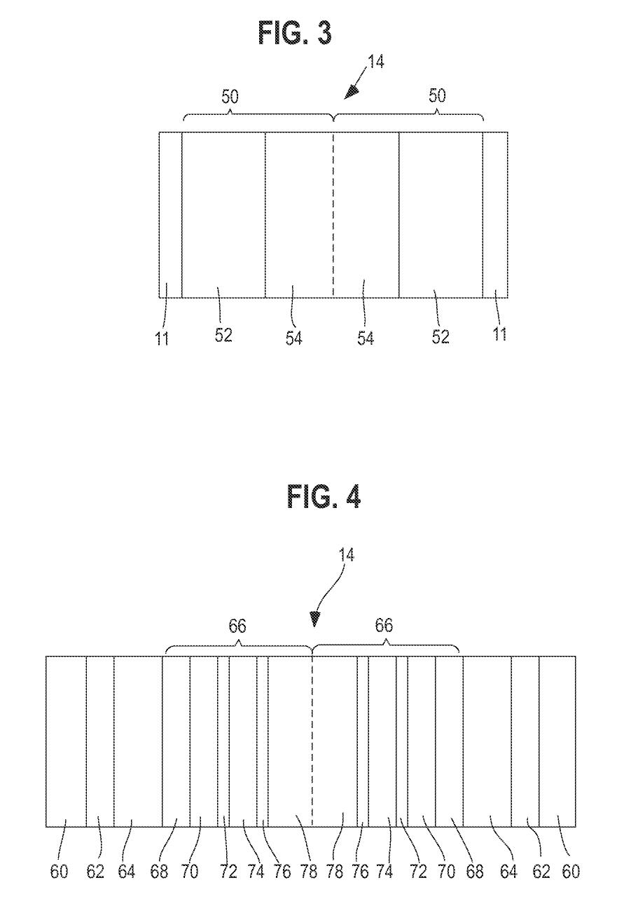

FIG. 3 shows yet another example utilizing oriented polyethylene terephthalate (PET) that provides structure, moisture barrier, and oxygen barrier properties to the film. In this example, the seal structure includes the outer protective coating 11 and two facing oriented PET film layers 50 to provide the hermetic seal 14. In this approach, each oriented polymer film includes an outer PET layer 52 and an inner extrusion coated PET sealant layer 54. Similar to the above films, the oriented PET films 50 may be stretched or oriented about 9 times or about 3 times each in a crosswise and lengthwise direction.

FIG. 4 shows another example of a suitable film construction that incorporates a reverse printed outer layer. In this example, the hermetic seal structure includes an outer oriented polymer layer 60, a printed ink layer 62, an adhesive layer 64, and an oriented polymer layer 66 including an oxygen barrier to provide the hermetic seal 14. Each oriented polymer layer 64 may include an outer polyolefin homopolymer or copolymer layer 68, a polyolefin layer 70, an adhesive or tie layer 72, an oxygen barrier layer 74, another adhesive or tie layer 76, and an inner polyolefin homopolymer or copolymer layer 78 suitable for forming the hermetic seal 14.

As with the other oriented polymer films, the oriented polymer layers in the seal structure of FIG. 4 may be oriented in a similar manner and to a similar degree. By one approach, the outer oriented polymer layer may include oriented polypropylene, the adhesive layer 64 may be an extruded polyethylene adhesive, the outer polyolefin homopolymer or copolymer layer 68 may include ethylene, propylene, or a copolymer thereof, the polymer layer 70 may include polypropylene, the oxygen barrier layer may include EVOH, and the inner layer 78 may also be a homopolymer or copolymer of include ethylene, propylene, or a blends thereof.

One suitable method of forming the hermetic seals with such thermal and dimensional stability is by using an impulse-type sealing unit on a vertical form, fill, and sealing line. One example is provided by Ceetak Ltd that is configured to form a seal by controlling a current flow through a ceramic coated low mass ribbon that can generate high levels of heat very quickly. In some cases, the complete cycle of heating lasts only about 0.2 to about 0.5 seconds. The heating profiles may range from about 260° C. to about 300° C. The hermetic seal is enhanced and the packages are separated form one another by a corner edge of a hard engineered polymer that is capable of cutting through the softer packaging film after it has been heated to a softening point about 100° C. hotter than traditional heat sealing methods. This hot cutting action secures the hermetic seal. At the same time, with the sealing jaws from this sealer still constraining the film, the seal is cooled by chilled water circulating through the sealing jaws. After cooling, the jaws release the material. In some instances, the combination of the selected oriented polymer films together with the selected sealing methods are advantageous because the hermetic welded seam is produced at the required high temperatures for the oriented films, but the film is quickly cooled while still under restraint from the sealing jaws. Thus, the film is quickly cooled before it has a chance to deform or distort.

One advantage of the impulse-type sealing method is the combined heating and cooling profiles of the clamping jaws. Another advantage of the impulse-type sealer is that it forms seals with a much smaller footprint on the overall package films. The seals may be, in some cases, as narrow as about 2.4 mm and in other cases only about 1 to about 3 mm wide and still achieve a high degree of hermeticity forming no bubbles in underwater vacuum testing at about 15 to about 25 inches of mercury. This can even be achieved with the films described herein with at least one fold or wrinkle formed in or embedded in the hermetic seal 14.

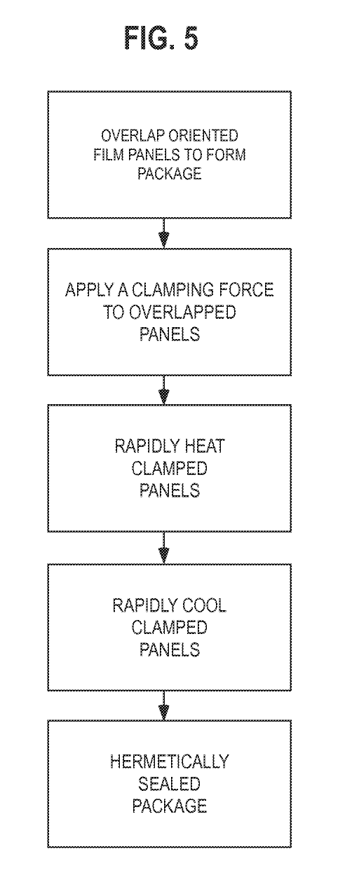

Turning to FIG. 5, and exemplary method of forming a hermetically sealed, high oxygen barrier flexible package formed out of oriented polymer films where the hermetic seals demonstrate high levels of thermal and dimensional stability is shown. The method is suitable for incorporation into a high speed commercial bagging operation. First, panels of a flexible oriented polymer film are aligned in an overlapping relationship to form a package. The flexible oriented polymer films may be those described above and, in one approach, includes an oxygen barrier layer effective to limit oxygen transfer through the film to about 1 cc per 100 in² per 24 hours of oxygen or less. Next, a heat sealing apparatus is used to form a hermetic heat seal by applying a clamping force through closed jaws or other clamping device to the overlapped and aligned flexible oriented polymer film panels. To form the heat seal, heat is rapidly applied to closed jaws or other clamping device in an amount and for a time effective to melt at least inner portions of the oriented flexible polymer films. While the clamping jaws or other clamping device is still clamped or closed on the film, the jaws and film are rapidly cooled to form a hermetic seal between the flexible polymer film panels. So formed, the hermetic seal provides the thermal and dimensional stability described above.

The films described herein may also be used with ultrasonic-type heat sealing equipment.

In yet other approaches, the packaging films and hermetic seals described herein may optionally include or be used with pressure sensitive reclose features and/or low tack pressure sensitive cohesive layers for use as a reclosable fastener. The films and hermetic seals may also be used with press-to-close single and double track zipper and other types of mating fasters. In some approaches, to form a suitable bond to the low tack adhesive, the inner facing layers of the package film may include a filler having a construction and in an amount effective to form a suitable bond to the low tack adhesive. Examples of the low tack adhesive and film including effective constructions of the filler are described in provisional patent applications 61/305,540 filed Feb. 26, 2010 and 61/407,406 filed Oct. 27, 2010, both of which are incorporated herein by reference in their entirety.

It will be understood that various changes in the details, materials, and arrangements of the process, formulations, and ingredients thereof, which have been herein described and illustrated in order to explain the nature of the films, hermetic seals, and methods may be made by those skilled in the art within the principle and scope of the embodied method as expressed in the appended claims.

What is claimed is:

1. A hermetic seal of an oxygen barrier oriented polymer films comprising:
opposing front and back panels of a flexible oriented polymer film;
an oxygen barrier layer of the polymer film effective to limit oxygen transfer through the film to about 1 cc per 100 in² per 24 hours of oxygen or less; and
a hermetic seal between the front and back panels of the flexible oriented polymer film having thermal and dimensional stability upon being heat sealed.

2. The package of claim 1, wherein the flexible oriented polymer film is a biaxially oriented polypropylene or a biaxially oriented PET.

3. The package of claim 1, wherein the hermetic seal is formed by rapidly applying heat to the front and back panels between clamping jaws of a heat seal apparatus and then rapidly cooling the clamping jaws and front and back panels when the clamping jaws are still clamped.

4. The package of claim 1, wherein the thermal and dimensional stability upon being heat sealed is about 5 percent or less shrinkage of the flexible oriented polymer film.

5. The package of claim 1, wherein the oxygen barrier layer is EVOH.

6. A method of forming a hermetically sealed, high oxygen barrier flexible package, the method comprising:
aligning panels of a flexible oriented polymer film in an overlapping relationship, the flexible oriented polymer film including an oxygen barrier layer effective to limit oxygen transfer through the film to about 1 cc per 100 in² per 24 hours of oxygen or less;
applying a clamping force to the overlapped and aligned flexible oriented polymer film panels;
rapidly heating the clamped overlapped film panels;
rapidly cooling the still clamped overlapped film panels to form a hermetic seal between the flexible polymer film panels.

7. The method of claim 6, wherein the flexible oriented polymer film is a biaxially oriented polypropylene film.

8. The method of claim 6, wherein the oxygen barrier layer is EVOH.
